(19) United States
(12) Patent Application Publication
(10) Pub. No.: US 2019/0376647 A1
(43) Pub. Date: Dec. 12, 2019

(54) CONNECTION STRUCTURE

(71) Applicant: NTT DOCOMO, INC., Chiyoda-ku, Tokyo (JP)

(72) Inventor: Makoto TAKIMOTO, Chiyoda-ku (JP)

(73) Assignee: NTT DOCOMO, INC., Chiyoda-ku, Tokyo (JP)

(21) Appl. No.: 16/462,796

(22) PCT Filed: Oct. 17, 2017
(86) PCT No.: PCT/JP2017/037541

§ 371 Date: May 21, 2019

(30) Foreign Application Priority Data
Nov. 22, 2016 (JP) 2016-226844

(51) Int. Cl. F16M 13/04; F16M 11/06; H04B 1/3888

(52) U.S. Cl. CPC F16M 13/04; H04B 1/3888; F16M 11/06

(57) ABSTRACT

A connection structure 10 according to one aspect connects a stationary member 20 and a finger ring member 30 with a magnetic force. The attraction section 22 and the attraction section 34 are formed such that the stationary member 20 and the finger ring member 30 are connected so as to be rotatable relative to each other about a rotation axis C. The attraction section 22 and the attraction section 34 are formed such that the magnetic force by which the attraction section 22 and the attraction section 34 are attracted to each other is stronger when the relative positional relationship between the stationary member 20 and the finger ring member 30 in accordance with the relative rotation is any of a plurality of specific positional relationships than when the relative positional relationship is not the specific positional relationship.

### TECHNICAL FIELD

One aspect of the present invention relates to a connection structure connecting two members.

### BACKGROUND ART

Patent Literature 1 discloses the structure of connection sections connecting two members (lens holding and ear hook parts of a frame for glasses) so as to be rotatable relative to each other. In this structure, the connection section of one of the members (hereinafter, referred to as “first connection section”) and the connection section of the other member (hereinafter, referred to as “second connection section”) are connected by magnets respectively provided in the connection sections. In this structure, the second connection section is rotatable relative to the first connection section in a state where the upper surface of the first connection section is in contact with the lower surface of the second connection section and the second connection section is attracted to the first connection section by a magnetic force.

### CITATION LIST

### Patent Literature

Patent Literature 1: Japanese Unexamined Patent Publication No. H10-284317

### SUMMARY OF INVENTION

### Technical Problem

It is conceivable to use a connection structure as described above so that, for example, a first member provided on the back surface of a smartphone and a second member attached to a user's finger or the like are connected so as to be rotatable relative to each other between a state where the smartphone is vertically held (vertical state) and a state where the smartphone is laterally held (lateral state). In this case, it is preferable that the second member is firmly fixed to the first member in the vertical state or the lateral state and the second member is smoothly rotated relative to the first member during switching from one of the vertical state and the lateral state to the other. Users' operability can be improved when modulated rotational operation of a second member with respect to a first member is realized in a structure connecting the first and second members as described above.

In the connection structure disclosed in Patent Literature 1, the two disk-shaped magnets have substantially the same size, and thus the force at which the first and second connection sections are attracted by the magnets (that is, the area in which the two magnets overlap when viewed from the direction in which the first and second connection sections face each other) is constant regardless of the relative positional relationship between the first and second connection sections. As a result, the force that is necessary for rotation of the second connection section relative to the first connection section is constant regardless of the relative positional relationship, and thus no modulated rotational operation can be realized.

An object of one aspect of the present invention is to provide a connection structure allowing modulated rotational operation of a second member with respect to a first member.

### Solution to Problem

A connection structure according to one aspect of the present invention connects a first member and a second member with a magnetic force. The first member has a first attraction section including an attraction piece as a magnet or a magnetic body. The second member has a second attraction section including an attraction piece as a magnet or a magnetic body and connecting the first member and the second member by being attracted to the first attraction section by a magnetic force. The first attraction section and the second attraction section are formed such that the first member and the second member are connected so as to be rotatable relative to each other about a rotation axis parallel to a direction of connection in which the first member and the second member are connected. The first attraction section and the second attraction section are formed such that a magnetic force by which the first attraction section and the second attraction section are attracted is stronger when a relative positional relationship between the first member and the second member in accordance with the relative rotation is any of a plurality of specific positional relationships than when the relative positional relationship is not the specific positional relationship.

In the connection structure according to one aspect of the present invention, the first member and the second member are connected so as to be rotatable relative to each other about the rotation axis parallel to the direction of connection and the magnetic force by which the first attraction section and the second attraction section are attracted varies with the relative positional relationship in accordance with the relative rotation of the first member and the second member. Specifically, the magnetic force by which the first attraction section and the second attraction section are attracted is stronger when the relative positional relationship is any of the plurality of specific positional relationships than when the relative positional relationship is not the specific positional relationship. As a result, the second member can be relatively firmly fixed to the first member when the relative positional relationship is the specific positional relationship and the second member can be relatively smoothly rotated relative to the first member when the relative positional relationship is between the plurality of specific positional relationships. Accordingly, modulated rotational operation of the second member with respect to the first member is possible with the connection structure.

### Advantageous Effects of Invention

According to one aspect of the present invention, it is possible to provide a connection structure allowing modulated rotational operation of a second member with respect to a first member.

### BRIEF DESCRIPTION OF DRAWINGS

FIG. 1 is a diagram illustrating a connection structure according to a first embodiment, in which a part (a) illustrates a connected state and a part (b) illustrates a disconnected state.

FIG. 2 is a diagram illustrating an example of use of the connection structure according to the first embodiment, in which a part (a) illustrates a state where a smartphone is vertically held and a part (b) illustrates a state where the smartphone is laterally held.

A part (a) of FIG. 3 is a plan view of a stationary member and a part (b) of FIG. 3 is a side view of the stationary member.

A part (a) of FIG. 4 is a first side view of a finger ring member, a part (b) of FIG. 4 is a second side view of the finger ring member, and a part (c) of FIG. 4 is a bottom view of the finger ring member.

FIG. 5 is a diagram illustrating a state where attraction sections overlap each other in accordance with the relative positional relationship of the finger ring member with respect to the stationary member in the connection structure according to the first embodiment.

FIG. 6 is a diagram illustrating a connection structure according to a second embodiment, in which a part (a) illustrates a connection surface of a stationary member and a part (b) illustrates a connection surface of a finger ring member.

FIG. 7 is a diagram illustrating a state where attraction sections overlap each other in accordance with the relative positional relationship of the finger ring member with respect to the stationary member in the connection structure according to the second embodiment.

FIG. 8 is a diagram illustrating a connection structure according to a third embodiment, in which a part (a) illustrates a connection surface of a stationary member and a part (b) illustrates a connection surface of a finger ring member.

FIG. 9 is a diagram illustrating a state where attraction sections overlap each other in accordance with the relative positional relationship of the finger ring member with respect to the stationary member in the connection structure according to the third embodiment.

FIG. 10 is a diagram illustrating a connection structure according to a fourth embodiment, in which a part (a) illustrates a connection surface of a stationary member and a part (b) illustrates a connection surface of a finger ring member.

FIG. 11 is a diagram illustrating a state where attraction sections overlap each other in accordance with the relative positional relationship of the finger ring member with respect to the stationary member in the connection structure according to the fourth embodiment.

FIG. 12 is a cross-sectional view of a stationary member according to a modification example.

### DESCRIPTION OF EMBODIMENTS

Hereinafter, an embodiment of the present invention will be described in detail with reference to accompanying drawings. In the description of the drawings, the same or corresponding elements will be denoted by the same reference numerals without redundant description.

### First Embodiment

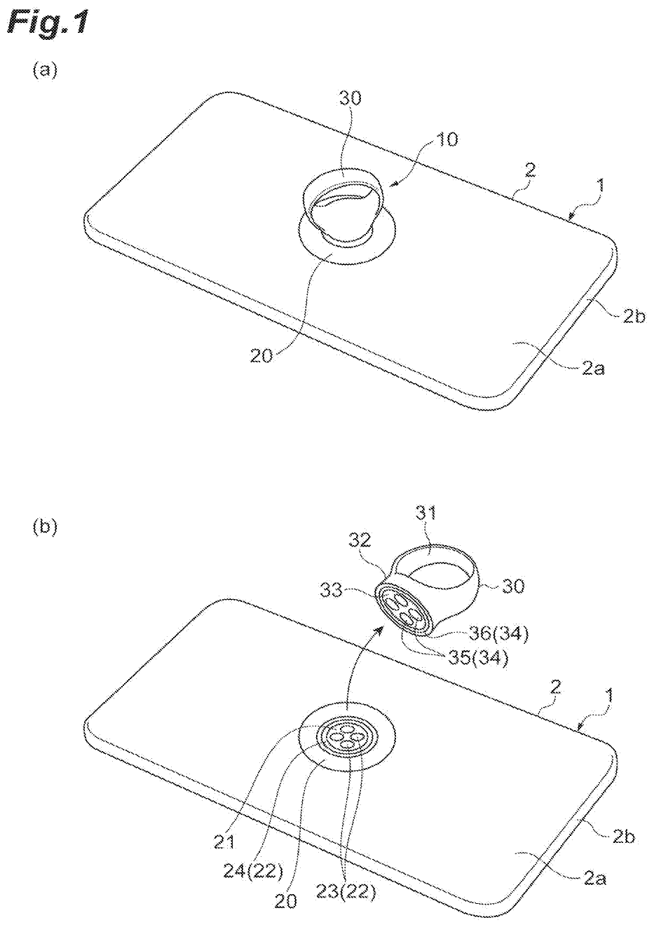

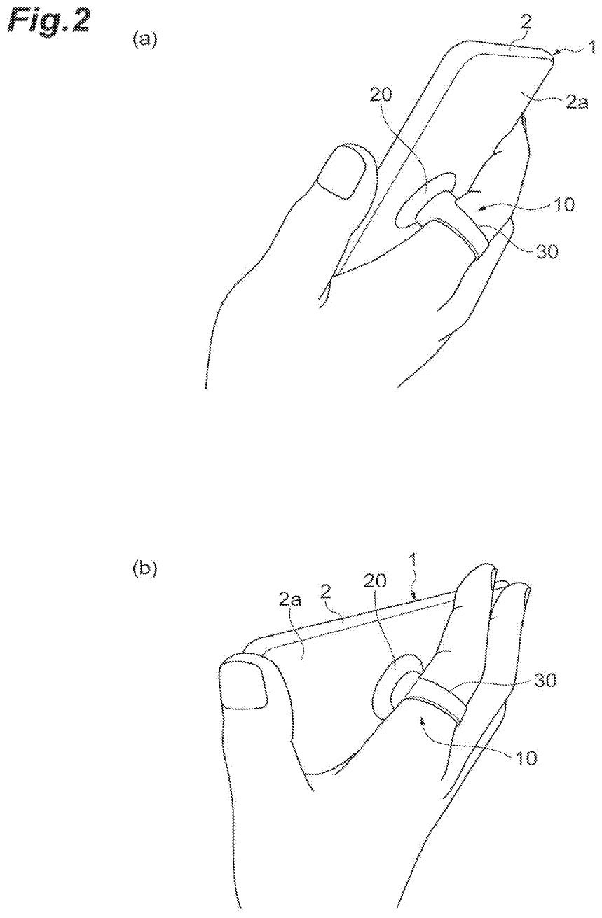

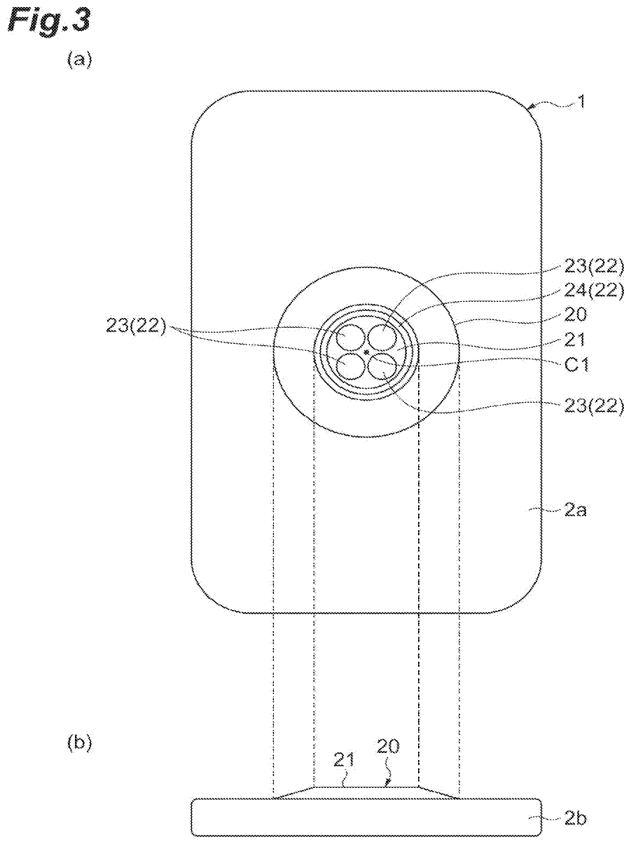

FIG. 1 is a diagram illustrating a connection structure 10 according to a first embodiment. FIG. 2 is a diagram illustrating an example of use of the connection structure 10. As illustrated in FIGS. 1 and 2, in the present embodiment, the connection structure 10 is a connection structure used so that, for example, a smartphone 1 is held. More specifically, the connection structure 10 is used so that the smartphone 1 is prevented from falling or the smartphone 1 is held with ease. Here, the smartphone 1 is provided with a substantially rectangular parallelepiped housing 2, electronic components stored in the housing 2, and the like. The smartphone 1 has a substantially rectangular parallelepiped outer shape.

The connection structure 10 is provided with a stationary member 20 (first member) fixed to a back surface 2a of the housing 2 and a finger ring member 30 (second member) attached to a finger of a user holding the smartphone 1. A part (a) of FIG. 1 illustrates a connected state where the finger ring member 30 is connected to the stationary member 20 fixed to the back surface 2a of the housing 2. A part (b) of FIG. 1 illustrates a state where the connection of the finger ring member 30 to the stationary member 20 is released. The finger ring member 30 is removable with respect to the stationary member 20 for the following reason. The finger ring member 30 that remains connected to the stationary member 20 hinders use or storage in some cases. This problem is solved when the finger ring member 30 is removable with respect to the stationary member 20.

The configuration of the stationary member 20 will be described with reference to FIG. 3. A part (a) of FIG. 3 is a plan view of the stationary member 20 and the smartphone 1 as viewed from a direction facing the back surface 2a of the housing 2. A part (b) of FIG. 3 is a side view of the stationary member 20 and the smartphone 1 as viewed from a direction facing a side surface 2b of the housing 2 (lower surface in a case where the smartphone 1 is vertically used). As illustrated in FIG. 3, the stationary member 20 is formed in a flat truncated cone shape. Although the shape of the stationary member 20 is not limited thereto, the flat and inconspicuous shape is capable of suppressing the stationary member 20 impairing the user's feeling of use in a case where, for example, the smartphone 1 is used with the finger ring member 30 not connected to the stationary member 20.

The bottom surface of the stationary member 20 is fixed to the back surface 2a of the housing 2 by, for example, a double-sided tape. Methods for fixing the bottom surface of the stationary member 20 to the back surface 2a are not limited thereto. For example, the bottom surface of the stationary member 20 may be fixed to the back surface 2a by a suction cup being provided on the bottom surface of the stationary member 20 and the suction cup being attracted to the back surface 2a. The stationary member 20 may be embedded in the back surface 2a. For example, the stationary member 20 may be embedded in the back surface 2a such that a connection surface 21, which will be described later, is substantially flush with the back surface 2a. In this case, the user's feeling of use being impaired by the stationary member 20 can be more effectively suppressed. In a case where a shock-absorbing cover member formed of plastic, rubber, or the like is attached to the smartphone 1, the stationary member 20 may be fixed to or embedded in the cover member.

The circular connection surface 21 is formed on the upper surface of the stationary member 20. The connection surface 21 abuts against a connection surface 33 (described in detail later) of the finger ring member 30 in the connected state. The stationary member 20 is provided with an attraction section 22 (first attraction section). The attraction section 22 and an attraction section 34 (described in detail later) of the finger ring member 30 are attracted to each other by a magnetic force. The attraction section 22 has four attraction pieces 23 (first attraction pieces) and an attraction piece 24 (third attraction piece). The four attraction pieces 23 and the attraction piece 24 are magnets or magnetic bodies that can be magnetized by a magnet.

Each of the four attraction pieces 23 is formed in a columnar shape extending in the thickness direction of the stationary member 20. The four attraction pieces 23 are disposed at predetermined intervals (at an interval of 90 degrees here) along the circumference of a circle about a center C1 of the connection surface 21 as viewed from the thickness direction of the stationary member 20. In the present embodiment, the four attraction pieces 23 are disposed in, for example, two rows and two columns so as to be parallel to each of the longitudinal direction and the short direction of the smartphone 1. The attraction piece 24 is formed in an annular shape about the center C1 of the connection surface 21 so as to surround the four attraction pieces 23 when viewed from the thickness direction of the stationary member 20.

In the present embodiment, the four attraction pieces 23 and the attraction piece 24 are embedded in the stationary member 20 such that, for example, the outer surfaces of the four attraction pieces 23 and the attraction piece 24 (surfaces on the side that the connection surface 21 faces) are flush with the connection surface 21. The four attraction pieces 23 and the attraction piece 24 do not necessarily have to be formed so as to be flush with the connection surface 21. For example, the four attraction pieces 23 and the attraction piece 24 may protrude from the connection surface 21. In a case where it is possible to maintain the connection between the connection surface 21 and the connection surface 33 (described in detail later) of the finger ring member 30 simply with the suction force that is generated between the attraction section 34 (described in detail later) of the finger ring member 30 and the four attraction pieces 23 and the attraction piece 24, for example, the four attraction pieces 23 and the attraction piece 24 may be embedded in the stationary member 20 such that the outer surfaces are positioned at positions recessed inward from the connection surface 21.

The configuration of the finger ring member 30 will be described with reference to FIG. 4. A part (a) of FIG. 4 is a first side view of the finger ring member 30 as viewed from the direction (Y axis direction) in which the user's finger is inserted through the finger ring member 30. A part (b) of FIG. 4 is a second side view of the finger ring member 30 as viewed from an X axis direction, which is orthogonal to the Y axis direction. A part (c) of FIG. 4 is a bottom view of the finger ring member 30 as viewed from a Z axis direction, which is orthogonal to the X axis direction and the Y axis direction. As illustrated in FIG. 4, the finger ring member 30 has a belt-shaped ring section 31 and a flat-and-columnar connection section 32. The ring section 31 forms a space S having a substantially circular cross section. The user's finger is inserted through the space S. The connection section 32 is connected to the outside of the ring section 31.

The circular connection surface 33 is formed on the surface of the connection section 32 that is on the side which is opposite to the side connected to the ring section 31. The connection surface 33 abuts against the connection surface 21 of the stationary member 20 in the connected state. The connection section 32 is provided with the attraction section 34 (second attraction section). The attraction section 22 of the stationary member 20 and the attraction section 34 are attracted to each other by a magnetic force. The connection surface 21 of the stationary member 20 and the connection surface 33 of the finger ring member 30 are connected by the attraction section 22 and the attraction section 34 being attracted (suctioned or attracted to each other). The attraction section 34 has four attraction pieces 35 (second attraction pieces) and an attraction piece 36 (fourth attraction piece), which are disposed so as to correspond to the four attraction pieces 23 and the attraction piece 24 of the attraction section 22. Specifically, the attraction pieces 35 and 36 have the same shape as the attraction pieces 23 and 24 and are disposed similarly to the attraction pieces 23 and 24. The four attraction pieces 35 and the attraction piece 36 are magnets or magnetic bodies that can be magnetized by a magnet.

Each of the four attraction pieces 35 is formed in a columnar shape extending in the thickness direction of the connection section 32 (Z axis direction). The four attraction pieces 35 are disposed at predetermined intervals (at an interval of 90 degrees here) along the circumference of a circle about a center C2 of the connection surface 33 as viewed from the Z axis direction. The four attraction pieces 35 are disposed in two rows and two columns so as to be misaligned by 45 degrees with respect to each of the X axis direction and the Y axis direction. The attraction piece 36 is formed in an annular shape about the center C2 of the connection surface 33 so as to surround the four attraction pieces 35 when viewed from the Z axis direction.

In the present embodiment, the four attraction pieces 35 and the attraction piece 36 are embedded in the connection section 32 such that, for example, the outer surfaces of the four attraction pieces 35 and the attraction piece 36 (surfaces on the side that the connection surface 33 faces) are flush with the connection surface 33. The four attraction pieces 35 and the attraction piece 36 do not necessarily have to be formed so as to be flush with the connection surface 33. For example, the four attraction pieces 35 and the attraction piece 36 may protrude from the connection surface 33. In a case where it is possible to maintain the connection between the connection surface 21 and the connection surface 33 as described above simply with the suction force that is generated between the attraction section 22 of the stationary member 20 and the four attraction pieces 35 and the attraction piece 36, for example, the four attraction pieces 35 and the attraction piece 36 may be embedded in the connection section 32 such that the outer surfaces are positioned at positions recessed inward from the connection surface 33.

The attraction section 22 of the stationary member 20 and the attraction section 34 of the finger ring member 30 are a combination that generates a magnetic force for mutual attraction or suction in a case where the connection surface 21 and the connection surface 33 face each other and the attraction section 22 and the attraction section 34 are close to or abut against each other. For example, each of the attraction section 22 (attraction pieces 23 and 24) and the attraction section 34 (attraction pieces 35 and 36) is formed by a magnet and disposed such that different polarities face each other in a case where the connection surface 21 and the connection surface 33 face each other. Alternatively, one of the attraction section 22 and the attraction section 34 may be formed by a magnet and the other of the attraction section 22 and the attraction section 34 may be formed by a magnetic body that can be magnetized by a magnet. The magnetic force by which the attraction section 22 and the attraction section 34 are attracted to each other has a magnitude at which the finger ring member 30 is not released with respect to the stationary member 20 and is adjusted to a magnitude at which the user can rotate the finger ring member 30 relative to the stationary member 20 with the force of the finger.

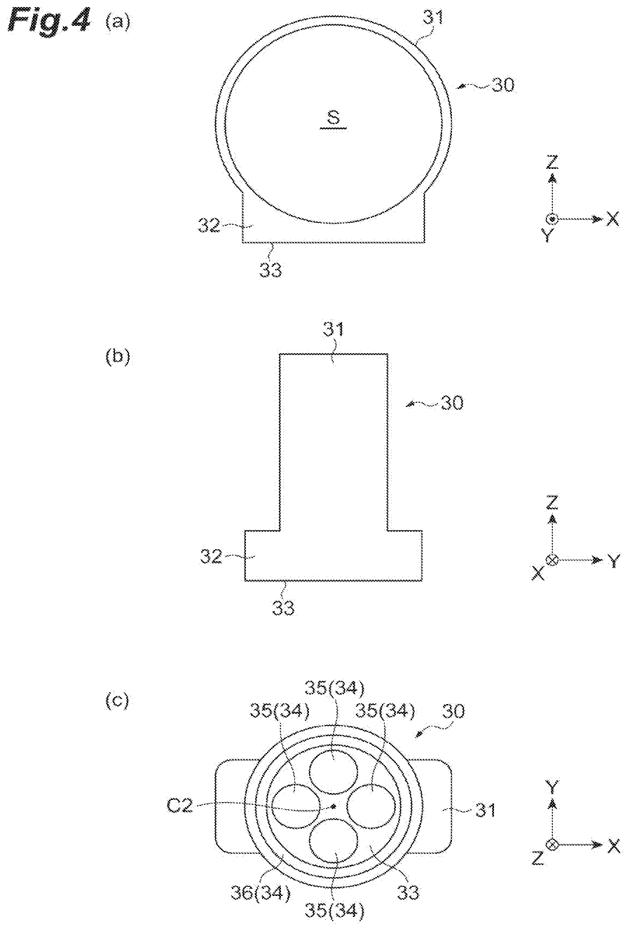

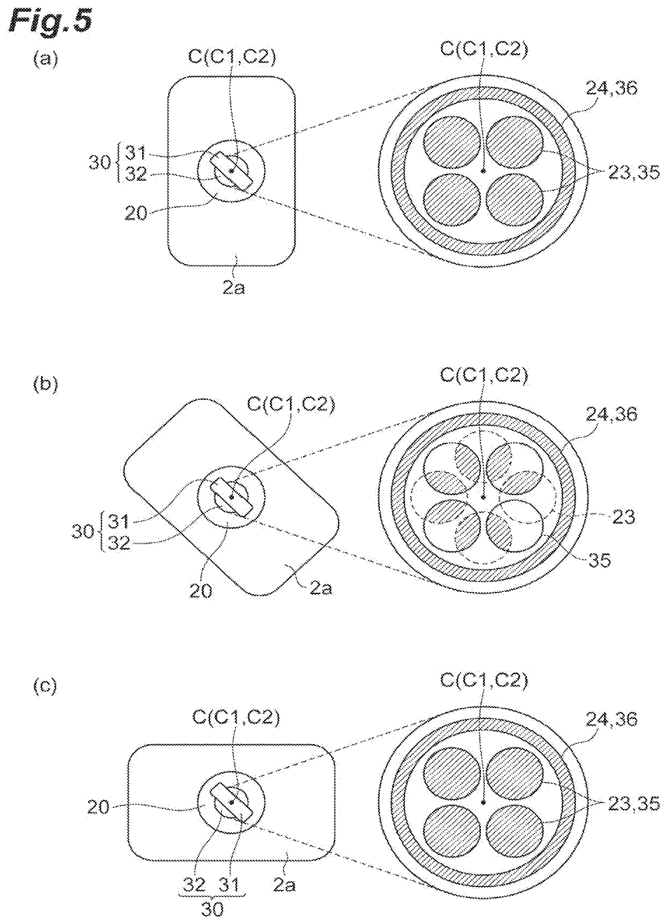

FIG. 5 is a diagram illustrating a state where the attraction section 22 and the attraction section 34 overlap each other in accordance with the relative positional relationship of the finger ring member 30 with respect to the stationary member 20 in the connection structure 10. The hatched parts in FIG. 5 indicate regions where the attraction section 22 and the attraction section 34 overlap each other when viewed from the direction of connection in which the stationary member 20 and the finger ring member 30 are connected (that is, the direction in which the connection surface 21 and the connection surface 33 face each other).

Each of parts (a) to (c) of FIG. 5 illustrates a state where the stationary member 20 and the finger ring member 30 are connected by the connection surface 21 and the connection surface 33 abutting against each other. In each of the states, the connection surface 21 and the connection surface 33 abut against each other such that the center C1 of the connection surface 21 and the center C2 of the connection surface 33 overlap each other when viewed from the direction of connection. The connection surface 21 and the connection surface 33 are connected so as to be capable of performing relative rotation about a rotation axis C, which connects the center C1 of the connection surface 21 and the center C2 of the connection surface 33, by the attraction section 22 and the attraction section 34 being attracted by a magnetic force. The rotation axis C is parallel to the direction of connection.

The state that is illustrated in the part (a) of FIG. 5 corresponds to the state that is illustrated in the part (a) of FIG. 2 (hereinafter, referred to as “vertical state”). The state that is illustrated in the part (c) of FIG. 5 corresponds to the state that is illustrated in the part (b) of FIG. 2 (hereinafter, referred to as “lateral state”). By the four attraction pieces 23 of the stationary member 20 and the four attraction pieces 35 of the finger ring member 30 being disposed at the angle described above, the ring section 31 is inclined at an angle (of 45 degrees in the present embodiment) to the longitudinal direction or the short direction of the smartphone 1 in the vertical state or the lateral state. As a result, the user can insert the finger through the ring section 31 at a natural angle in the vertical state or the lateral state as illustrated in FIG. 2.

The state that is illustrated in the part (b) of FIG. 5 is an intermediate state during transition from the vertical state to the lateral state. Here, the relative positional relationship between the connection surface 21 and the connection surface 33 in each of the intermediate state and the lateral state is equivalent to the state that results from the connection surface 21 (stationary member 20) being rotated relative to the connection surface 33 (finger ring member 30) by 45 degrees and 90 degrees about the rotation axis C (in the counterclockwise direction in FIG. 5) based on the vertical state.

As illustrated in the part (a) and (c) of FIG. 5, in the vertical state or the lateral state, the four attraction pieces 23 and the attraction piece 24 of the stationary member 20 and the four attraction pieces 35 and the attraction piece 36 of the finger ring member 30 completely overlap each other when viewed from the direction of connection. At this time, the relative positional relationship between the connection surface 21 and the connection surface 33 in accordance with the relative rotation about the rotation axis C is a positional relationship in which the area of the region where the attraction section 22 and the attraction section 34 overlap each other when viewed from the direction of connection is maximized, that is, a positional relationship in which the magnetic force by which the attraction section 22 and the attraction section 34 are attracted is maximized (specific positional relationship).

A user who holds the smartphone 1 in the vertical state can rotate the smartphone 1 and the stationary member 20 about the rotation axis C relative to the finger ring member 30 attached to his or her finger by applying a force to, for example, a side surface of the smartphone 1 with his or her thumb or the like. The relative positional relationship between the connection surface 21 and the connection surface 33 changes in accordance with the relative rotation. The user goes through the intermediate state (see the part (b) of FIG. 5) once he or she rotates the smartphone 1 and the stationary member 20 about the rotation axis C relative to the finger ring member 30 for transition from the vertical state (see the part (a) of FIG. 5) to the lateral state (see the part (c) of FIG. 5).

As illustrated in the part (b) of FIG. 5, in the intermediate state, the four attraction pieces 23 of the stationary member 20 are misaligned by 45 degrees about the rotation axis C relative to the four attraction pieces 35 of the finger ring member 30. Accordingly, the area of the region where the four attraction pieces 23 and the four attraction pieces 35 overlap each other when viewed from the direction of connection is smaller than in the vertical state or the lateral state. Here, the area of the region where the four attraction pieces 23 and the four attraction pieces 35 overlap each other when viewed from the direction of connection decreases from the vertical state to the intermediate state, is minimized in the intermediate state, and increases from the intermediate state to the lateral state. In other words, the connection surface 21 and the connection surface 33 are firmly connected by a relatively strong magnetic force in the vertical state and the lateral state, and the magnetic force by which the attraction section 22 and the attraction section 34 are attracted weakens in the state of transition between the vertical state and the lateral state. As a result, the connection surface 33 can be relatively smoothly rotated relative to the connection surface 21 during transition from the vertical state to the lateral state (or transition from the lateral state to the vertical state). In addition, it is possible to easily remove the finger ring member 30 from the stationary member 20 by adjusting the position of the finger ring member 30 relative to the stationary member 20 to a position where the magnetic force weakens.

Although the area of the region where the four attraction pieces 23 and the four attraction pieces 35 overlap each other changes in accordance with the relative positional relationship between the connection surface 21 and the connection surface 33, the annular attraction piece 24 and the annular attraction piece 36 overlap in a constant area at all times regardless of the relative positional relationship. In other words, the attraction piece 24 and the attraction piece 36 are attracted with a constant magnetic force at all times regardless of the relative positional relationship. Even in a case where, for example, the magnetic force by which the four attraction pieces 23 and the four attraction pieces 35 are attracted weakens as in the state of transition including the intermediate state, a magnetic force for maintaining the connection between the stationary member 20 and the finger ring member 30 can be supplied by the attraction piece 24 and the attraction piece 36.

In the connection structure 10 described above, the connection surface 21 and the connection surface 33 are connected so as to be capable of performing relative rotation about the rotation axis C, which is parallel to the direction of connection, and the magnetic force by which the attraction section 22 and the attraction section 34 are attracted to each other varies with the relative positional relationship in accordance with the relative rotation of the connection surface 21 and the connection surface 33. Specifically, the magnetic force by which the attraction section 22 and the attraction section 34 are attracted to each other is stronger when the relative positional relationship is any of a plurality of the specific positional relationships (here, the vertical state or the lateral state illustrated in the part (a) or the part (c) of FIG. 5) than when the relative positional relationship is not the specific positional relationship (that is, when the relative positional relationship is between the vertical state and the lateral state). As a result, the connection surface 33 can be relatively firmly fixed to the connection surface 21 when the relative positional relationship is the specific positional relationship (vertical or lateral state here) and the connection surface 33 can be relatively smoothly rotated relative to the connection surface 21 when the relative positional relationship is between the plurality of specific positional relationships (vertical and lateral states here). Accordingly, modulated rotational operation of the finger ring member 30 with respect to the stationary member 20 is possible with the connection structure 10.

More specifically, switching with a click feeling can be realized between the vertical state and the lateral state by the connection structure 10. In a case where a user wishes to switch from one of the vertical state and the lateral state to the other, for example, the user needs to apply a relatively large force to a side surface of the smartphone 1 or the like so that the one state is released. Once the connection surface 33 starts to rotate about the rotation axis C relative to the connection surface 21, transition to the state of transition occurs and the magnetic force by which the attraction section 22 and the attraction section 34 are attracted weakens. As a result, the user can rotate the connection surface 33 relative to the connection surface 21 simply by applying a relatively small force. The magnetic force by which the attraction section 22 and the attraction section 34 are attracted becomes strong again once the other state is subsequently reached, and then the relative rotation stops. By means of the change in the magnitude of the magnetic force generated between the attraction section 22 and the attraction section 34, the user can be given the click feeling of the finger ring member 30 clicking into the stationary member 20 when the vertical state or the lateral state is reached. In addition, the user can feel, for example, a change in the magnitude of the force that needs to be applied with his or her finger or the like for rotation of the smartphone 1 and the stationary member 20 relative to the finger ring member 30 (weight applied to the finger) and a change in the speed of the relative rotation. As a result, a comfortable operation feeling can be provided for the user in rotational operation in a state where the connection between the stationary member 20 and the finger ring member 30 is maintained. In addition, detachment of the finger ring member 30 from the stationary member 20 is facilitated in the relative positional relationship (such as the intermediate state) in which the magnetic force by which the stationary member 20 and the finger ring member 30 are attracted weakens. As a result, the user's convenience can be improved also in operation for detaching the finger ring member 30 from the stationary member 20.

In the connection structure 10, the attraction section 22 and the attraction section 34 are formed such that the area of the region where the attraction section 22 and the attraction section 34 overlap when viewed from the direction of connection changes in accordance with relative rotation. The shapes and disposition of the attraction section 22 and the attraction section 34 allow, for example, adjustment of the relative positional relationship between the stationary member 20 and the finger ring member 30 in which the area is maximized and the magnetic force by which the attraction section 22 and the attraction section 34 are attracted is maximized. As a result, the above-described specific positional relationship (such as the vertical and lateral states here) can be appropriately set.

In the connection structure 10, the attraction section 22 has the plurality of attraction pieces 23 (four attraction pieces 23 here) disposed along the circumference of a circle about the rotation axis C and the attraction section 34 has the plurality of attraction pieces 35 (four attraction pieces 35 here) disposed so as to correspond to the plurality of attraction pieces 23. With the attraction pieces 23 and 35, it is possible to easily realize a configuration in which the region where the attraction section 22 and the attraction section 34 overlap changes in accordance with relative rotation.

In the connection structure 10, the attraction section 22 has the attraction piece 24 and the attraction section 34 has the attraction piece 36 formed such that the area of the region that overlaps the attraction piece 24 when viewed in the direction of connection does not change regardless of the relative positional relationship. The attraction piece 24 and the attraction piece 36 overlap in a constant area at all times regardless of the relative positional relationship between the connection surface 21 and the connection surface 33, and thus the connection surface 21 and the connection surface 33 can be attracted with a certain magnetic force or more at all times. As a result, a state where the connection surface 21 and the connection surface 33 are connected to each other can be stably maintained.

The attraction piece 24 and the attraction piece 36 are formed in an annular shape about the rotation axis C, and thus it is possible to achieve a guide function at a time when the connection surface 21 rotates about the rotation axis C relative to the connection surface 33. As a result, smooth relative rotation is possible and positional misalignment between the connection surface 21 and the connection surface 33 during relative rotation (that is, misalignment of the center C1 and the center C2 as viewed from the direction of connection) can be prevented.

### Second Embodiment

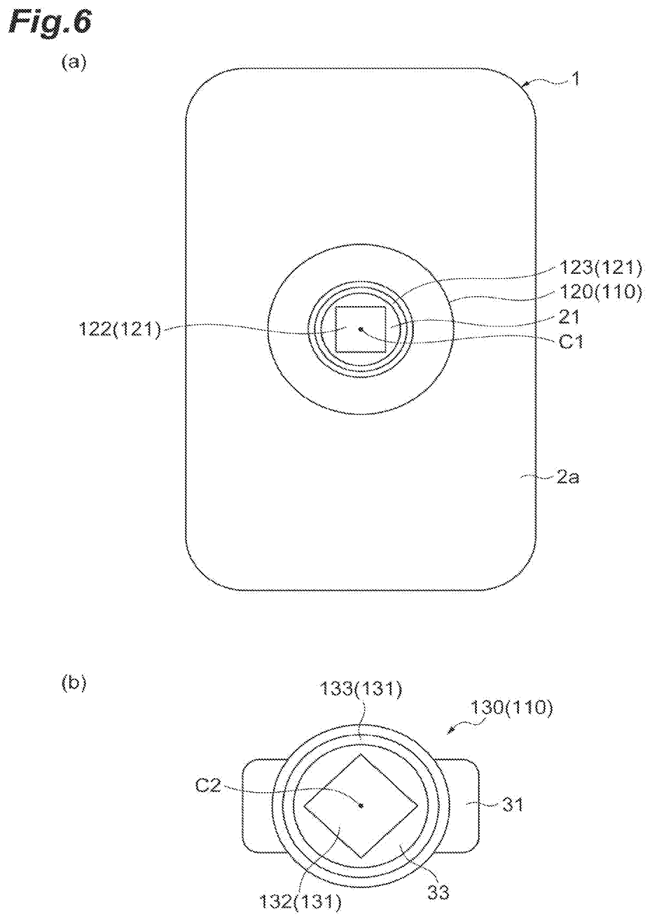

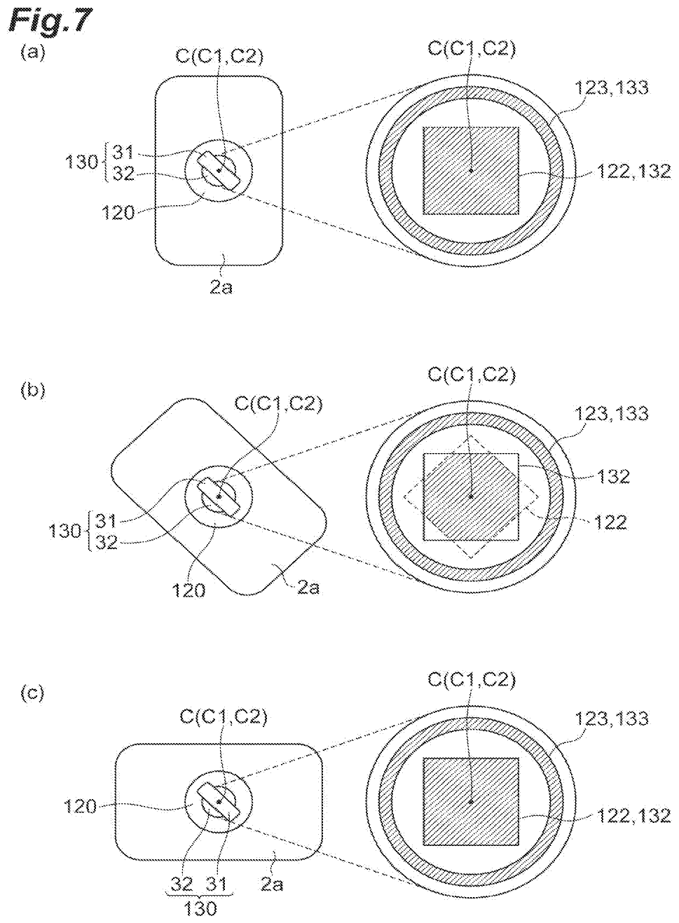

A connection structure 110 according to a second embodiment will be described with reference to FIGS. 6 and 7. The connection structure 110 is provided with a stationary member 120 and a finger ring member 130. The stationary member 120 is different from the stationary member 20 in that the stationary member 120 has an attraction section 121 instead of the attraction section 22. The stationary member 120 is similar to the stationary member 20 with regard to the other configurations. The finger ring member 130 is different from the finger ring member 30 in that the finger ring member 130 has an attraction section 131 instead of the attraction section 34. The finger ring member 130 is similar to the finger ring member 30 with regard to the other configurations.

As illustrated in a part (a) of FIG. 6, the attraction section 121 has a quadrangular prism-shaped attraction piece 122, which has a square cross section about the center C1 of the connection surface 21, and an annular attraction piece 123 about the center C1, which is similar to the attraction piece 24 of the connection structure 10. The attraction section 121 is different from the attraction section 22 of the connection structure 10 in that the attraction section 121 has the attraction piece 122 instead of the four attraction pieces 23. As illustrated in a part (b) of FIG. 6, the attraction section 131 has an attraction piece 132 and an attraction piece 133, which are disposed so as to correspond to the attraction piece 122 and the attraction piece 123. The angle at which the attraction piece 122 is disposed with respect to the smartphone 1 and the angle at which the attraction piece 132 is disposed with respect to the ring section 31 are adjusted such that a user can insert his or her finger through the ring section 31 at a natural angle (angle inclined with respect to the longitudinal direction or the short direction of the smartphone 1) in the vertical state or the lateral state.

FIG. 7 is a diagram illustrating a state where the attraction section 121 and the attraction section 131 overlap each other in accordance with the relative positional relationship of the finger ring member 130 with respect to the stationary member 120 in the connection structure 110. The hatched parts in FIG. 7 indicate regions where the attraction section 121 and the attraction section 131 overlap each other when viewed from the direction of connection. The state that is illustrated in a part (a) of FIG. 7 corresponds to the vertical state (see the part (a) of FIG. 2) and the state that is illustrated in a part (c) of FIG. 7 corresponds to the lateral state (see the part (b) of FIG. 2). The state that is illustrated in a part (b) of FIG. 7 is the intermediate state during transition from the vertical state to the lateral state.

As illustrated in the parts (a) and (c) of FIG. 7, in the vertical state or the lateral state, the attraction pieces 122 and 123 of the stationary member 120 and the attraction pieces 132 and 133 of the finger ring member 130 completely overlap each other when viewed from the direction of connection. At this time, the relative positional relationship between the connection surface 21 and the connection surface 33 in accordance with the relative rotation about the rotation axis C is a positional relationship in which the area of the region where the attraction section 121 and the attraction section 131 overlap each other when viewed from the direction of connection is maximized (specific positional relationship).

As illustrated in the part (b) of FIG. 7, in the intermediate state, the attraction piece 122 of the stationary member 120 is misaligned by 45 degrees about the rotation axis C relative to the attraction piece 132 of the finger ring member 130. Accordingly, the area of the region where the attraction piece 122 and the attraction piece 132 overlap each other when viewed from the direction of connection is smaller than in the vertical state or the lateral state. In other words, the connection surface 21 and the connection surface 33 are firmly connected by a relatively strong magnetic force in the vertical state and the lateral state, and the magnetic by which the attraction section 121 and the attraction section 131 are attracted weakens in the state of transition between the vertical state and the lateral state. As a result, the connection surface 33 can be relatively smoothly rotated relative to the connection surface 21 during transition from the vertical state to the lateral state (or transition from the lateral state to the vertical state).

The annular attraction piece 123 and the annular attraction piece 132 supply a magnetic force for maintaining the connection between the stationary member 120 and the finger ring member 130 similarly to the attraction piece 24 and the attraction piece 36 of the connection structure 10.

In the connection structure 110 described above, the attraction pieces 122 and 132 are provided so as to play roles similar to the roles of the attraction pieces 23 and 35 in the connection structure 10. Accordingly, with the connection structure 110, it is possible to realize modulated rotational operation of the finger ring member 30 with respect to the stationary member 20 by using the simpler shapes and disposition of the attraction sections 121 and 131.

### Third Embodiment

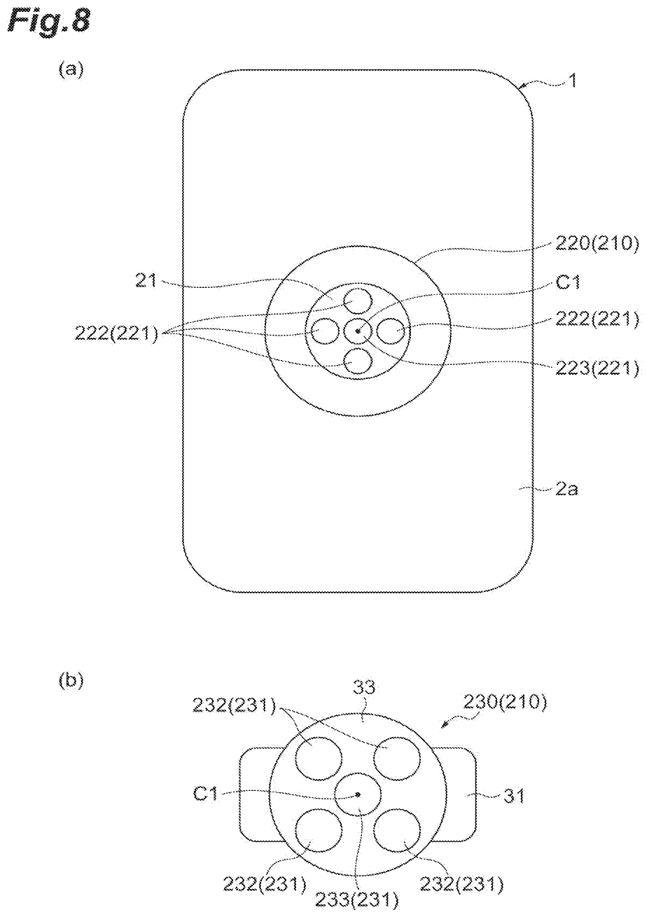

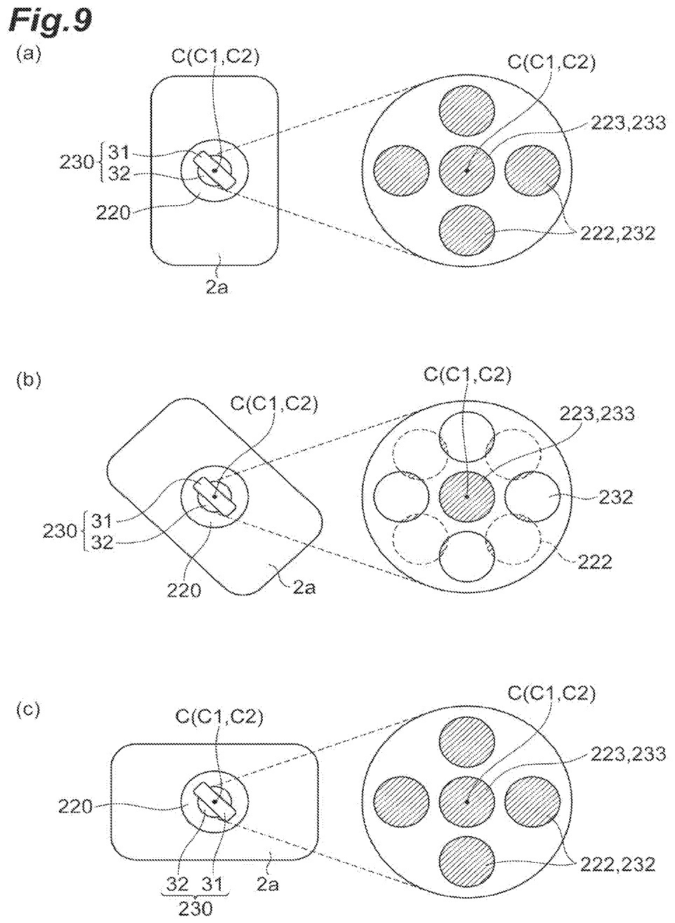

A connection structure 210 according to a third embodiment will be described with reference to FIGS. 8 and 9. The connection structure 210 is provided with a stationary member 220 and a finger ring member 230. The stationary member 220 is different from the stationary member 20 in that the stationary member 220 has an attraction section 221 instead of the attraction section 22. The stationary member 220 is similar to the stationary member 20 with regard to the other configurations. The finger ring member 230 is different from the finger ring member 30 in that the finger ring member 230 has an attraction section 231 instead of the attraction section 34. The finger ring member 230 is similar to the finger ring member 30 with regard to the other configurations.

As illustrated in a part of FIG. 8, the attraction section 221 has four attraction pieces 222 and an attraction piece 223. The four attraction pieces 222 are disposed at predetermined intervals (at an interval of 90 degrees here) along the circumference of a circle about the center C1 of the connection surface 21. The attraction piece 223 is formed in a columnar shape about the center C1 inside the four attraction pieces 222. The attraction section 221 is mainly different from the attraction section 22 of the connection structure 10 in that the attraction section 221 has the columnar attraction piece 223 instead of the annular attraction piece 24. As illustrated in a part (b) of FIG. 8, the attraction section 231 has attraction pieces 232 and an attraction piece 233, which are disposed so as to correspond to the attraction pieces 222 and the attraction piece 223. The angles at which the four attraction pieces 222 are disposed with respect to the smartphone 1 and the angles at which the four attraction pieces 232 are disposed with respect to the ring section 31 are adjusted such that a user can insert his or her finger through the ring section 31 at a natural angle (angle inclined with respect to the longitudinal direction or the short direction of the smartphone 1) in the vertical state or the lateral state.

FIG. 9 is a diagram illustrating a state where the attraction section 221 and the attraction section 231 overlap each other in accordance with the relative positional relationship of the finger ring member 230 with respect to the stationary member 220 in the connection structure 210. The hatched parts in FIG. 9 indicate regions where the attraction section 221 and the attraction section 231 overlap each other when viewed from the direction of connection. The state that is illustrated in a part (a) of FIG. 9 corresponds to the vertical state (see the part (a) of FIG. 2) and the state that is illustrated in a part (c) of FIG. 9 corresponds to the lateral state (see the part (b) of FIG. 2). The state that is illustrated in a part (b) of FIG. 9 is the intermediate state during transition from the vertical state to the lateral state.

As illustrated in the parts (a) and (c) of FIG. 9, in the vertical state or the lateral state, the attraction pieces 222 and 223 of the stationary member 220 and the attraction pieces 232 and 233 of the finger ring member 130 completely overlap each other when viewed from the direction of connection. At this time, the relative positional relationship between the connection surface 21 and the connection surface 33 in accordance with the relative rotation about the rotation axis C is a positional relationship in which the area of the region where the attraction section 221 and the attraction section 231 overlap each other when viewed from the direction of connection is maximized (specific positional relationship).

As illustrated in the part (b) of FIG. 9, in the intermediate state, the attraction piece 222 of the stationary member 220 is misaligned by 45 degrees about the rotation axis C relative to the attraction piece 232 of the finger ring member 230. Accordingly, the area of the region where the attraction piece 222 and the attraction piece 232 overlap each other when viewed from the direction of connection is smaller than in the vertical state or the lateral state. In other words, the connection surface 21 and the connection surface 33 are firmly connected by a relatively strong magnetic force in the vertical state and the lateral state, and the magnetic force by which the attraction section 221 and the attraction section 231 are attracted weakens in the state of transition between the vertical state and the lateral state. As a result, the connection surface 33 can be relatively smoothly rotated relative to the connection surface 21 during transition from the vertical state to the lateral state (or transition from the lateral state to the vertical state).

The columnar attraction piece 223 and the columnar attraction piece 233 are about the centers C1 and C2, respectively. The attraction piece 223 and the attraction piece 233 overlap in a constant area at all times regardless of the relative positional relationship. In other words, the attraction piece 223 and the attraction piece 233 are attracted with a constant magnetic force at all times regardless of the relative positional relationship. Even in a case where, for example, the magnetic force by which the four attraction pieces 222 and the four attraction pieces 232 are attracted weakens as in the state of transition including the intermediate state, a magnetic force for maintaining the connection between the stationary member 220 and the finger ring member 230 can be supplied by the attraction piece 223 and the attraction piece 233.

In the connection structure 210 described above, the attraction pieces 223 and 233 are provided so as to play roles similar to the roles of the attraction pieces 24 and 36 in the connection structure 10. Accordingly, despite the lack of the annular attraction pieces 24 and 36, a state where the connection surface 21 and the connection surface 33 are connected to each other can be stably maintained as in the case of the connection structure 10.

### Fourth Embodiment

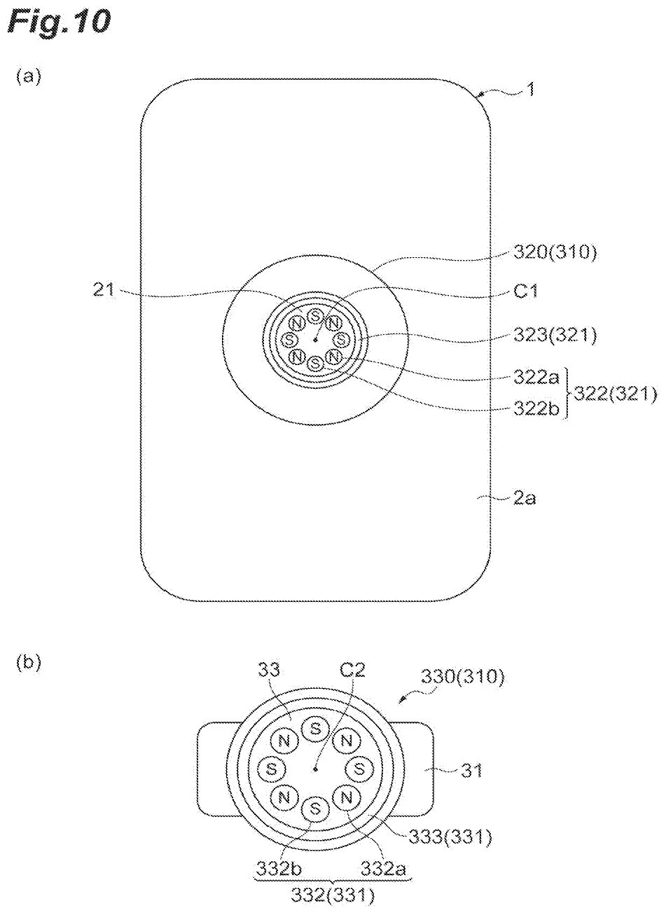

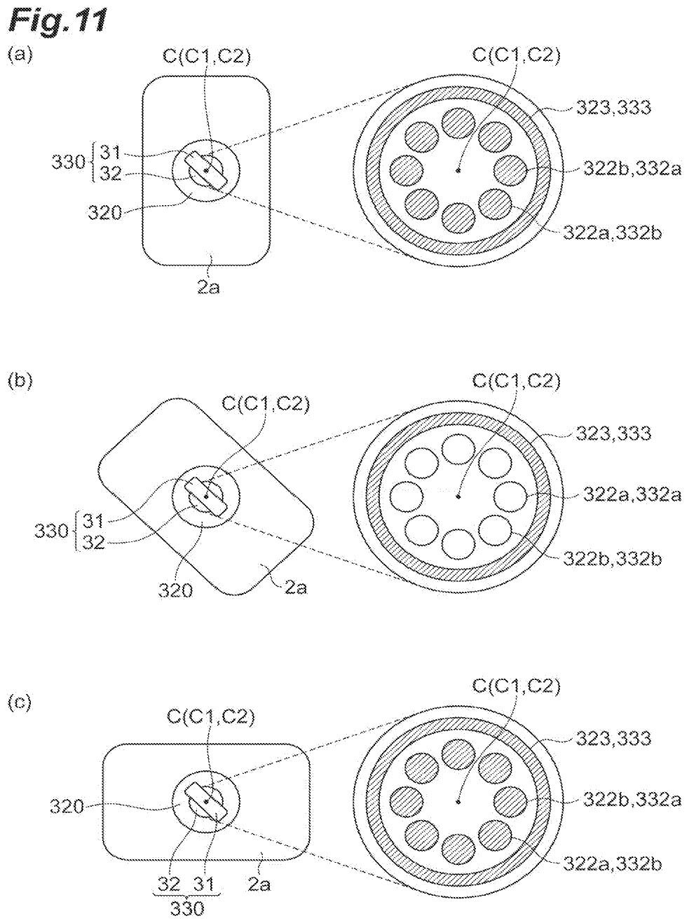

A connection structure 310 according to a fourth embodiment will be described with reference to FIGS. 10 and 11. The connection structure 310 is provided with a stationary member 320 and a finger ring member 330. The stationary member 320 is different from the stationary member 20 in that the stationary member 320 has an attraction section 321 instead of the attraction section 22. The stationary member 320 is similar to the stationary member 20 with regard to the other configurations. The finger ring member 330 is different from the finger ring member 30 in that the finger ring member 330 has an attraction section 331 instead of the attraction section 34. The finger ring member 330 is similar to the finger ring member 30 with regard to the other configurations.

As illustrated in a part (a) of FIG. 10, the attraction section 321 has eight attraction pieces 322 and an annular attraction piece 323. The eight attraction pieces 322 are disposed along the circumference of a circle about the center C1 of the connection surface 21. The attraction piece 323 is about the center C1 similarly to the attraction piece 24 of the connection structure 10. In other words, the attraction section 321 is different from the attraction section 22 of the connection structure 10 in that the attraction section 321 has the eight attraction pieces 322 instead of the four attraction pieces 23. The eight attraction pieces 322 include four attraction pieces 322a having an N pole (first polarity) and four attraction pieces 322b having an S pole (second polarity opposite to the first polarity), which are disposed in accordance with a predetermined distribution when viewed from a direction facing the connection surface 21. As illustrated in a part (b) of FIG. 10, the attraction section 331 has eight attraction pieces 332 and an attraction piece 333 disposed so as to correspond to the eight attraction pieces 322 and the attraction piece 323.

Here, the predetermined distribution is, for example, a distribution determined such that the number of pairs in which the attraction pieces 322 and 332 of the same polarity face each other and the number of pairs in which the attraction pieces 322 and 332 of different polarities face each other change in accordance with a predetermined rule in response to a change in the relative positional relationship of the attraction section 321 with respect to the attraction section 331. In this case, the relative positional relationship in which the difference (A-B) between the number A of pairs in which the attraction pieces 322 and 332 of the same polarity face each other and the number B of pairs in which the attraction pieces 322 and 332 of different polarities face each other is maximized corresponds to a specific positional relationship in which the connection surface 21 and the connection surface 33 are thinly connected by a relatively strong magnetic force.

In the present embodiment, the eight attraction pieces 322 are disposed such that, for example, the N pole (attraction piece 322a) and the S pole (attraction piece 322b) are alternate when viewed from a direction facing the connection surface 21. Likewise, the eight attraction pieces 332 are disposed such that the N pole (attraction piece 332a) and the S pole (attraction piece 332b) are alternate. The angles at which the eight attraction pieces 322 are disposed with respect to the smartphone 1 in view of the polarities and the angles at which the eight attraction pieces 332 are disposed with respect to the ring section 31 in view of the polarities are adjusted such that a user can insert his or her finger through the ring section 31 at a natural angle (angle inclined with respect to the longitudinal direction or the short direction of the smartphone 1) in the vertical state or the lateral state.

FIG. 11 is a diagram illustrating a state where the attraction section 321 and the attraction section 331 overlap each other in accordance with the relative positional relationship of the finger ring member 330 with respect to the stationary member 320 in the connection structure 310. The hatched parts in FIG. 11 indicate regions where the attraction section 321 and the attraction section 331 face each other with different polarities (or in a combination of magnetic force-based attraction). The state that is illustrated in a part (a) of FIG. 11 corresponds to the vertical state (see the part (b) of FIG. 2) and the state that is illustrated in a part (c) of FIG. 11 corresponds to the lateral state (see the part (b) of FIG. 2). The state that is illustrated in a part (b) of FIG. 11 is the intermediate state during transition from the vertical state to the lateral state.

As illustrated in the parts (a) and (c) of FIG. 11, in the vertical state or the lateral state, the eight attraction pieces 322 and the eight attraction pieces 332 face each other with different polarities. At this time, the relative positional relationship between the connection surface 21 and the connection surface 33 in accordance with the relative rotation about the rotation axis C is a positional relationship in which the magnetic force by which the attraction section 321 and the attraction section 331 are attracted when viewed from the direction of connection is maximized (specific positional relationship).

As illustrated in the part (b) of FIG. 11, in the intermediate state, the eight attraction pieces 322 of the stationary member 320 are misaligned by 45 degrees about the rotation axis C relative to the eight attraction pieces 332 of the finger ring member 330. In other words, the eight attraction pieces 322 and the eight attraction pieces 332 face each other with the same polarity in the intermediate state. Magnetic forces are generated in directions of mutual repulsion between the attraction piece 322 and the attraction piece 332 facing each other with the same polarity, and thus the magnetic force by which the attraction section 321 and the attraction section 331 are attracted weakens. As a result, the connection surface 21 and the connection surface 33 are firmly connected by a relatively strong magnetic force in the vertical state and the lateral state, and the magnetic force by which the attraction section 321 and the attraction section 331 are attracted weakens in the state of transition between the vertical state and the lateral state. As a result, the connection surface 33 can be relatively smoothly rotated relative to the connection surface 21 during transition from the vertical state to the lateral state (or transition from the lateral state to the vertical state).

The annular attraction piece 323 and the annular attraction piece 333 overlap in a constant area at all times regardless of the relative positional relationship. Here, the magnetic force by which the attraction piece 323 and the attraction piece 333 are attracted is adjusted so as to be stronger than the magnetic forces in the directions of mutual repulsion that are generated between the eight attraction pieces 322 and the eight attraction pieces 332 facing each other with the same polarity in the intermediate state (see the part (b) of FIG. 11). The adjustment may be performed by, for example, adjustment of the material, size, or the like of the magnet or the like that constitutes the attraction pieces 323 and 333. By means of the adjustment, it is possible to maintain a state where the connection surface 33 is connected by a magnetic force to the connection surface 21 even in the intermediate state where the magnetic force by which the attraction section 321 and the attraction section 331 are attracted is weakest as a whole.

In the connection structure 310 described above, the attraction pieces of different polarities (N-pole attraction pieces 322a and 332a and S-pole attraction pieces 322b and 332b here) are mixed, and thus it is possible to increase the difference in magnitude of the magnetic force by which the attraction section 321 and the attraction section 331 are attracted as a whole. Specifically, the difference in magnitude can be greater, by means of the generation of the magnetic forces of the same polarity in the directions of mutual repulsion, than in a case where such magnetic forces are not used. As a result, it is possible to realize further modulated rotational operation of the finger ring member 330 with respect to the stationary member 320.

Although the first to fourth embodiments have been described above, the embodiments are examples and can be appropriately modified within the spirit and scope of the present invention. Several modification examples focusing on the first embodiment will be described below. The following modification examples may be applied to the second to fourth embodiments as far as possible.

Although a configuration in which the four attraction pieces 23 and 35 are disposed at an interval of 90 degrees has been exemplified in the first embodiment, the interval at which the attraction pieces 23 and 35 are disposed may be an interval other than 90 degrees. In addition, the numbers of the attraction pieces 23 and 35 may be appropriately changed in accordance with the interval. The cross-sectional shapes of the attraction pieces 23 and 35 are not limited to a circular shape, and an elliptical shape, a polygonal shape, and any other shape can be adopted.

The plurality of attraction pieces 23 and 35 may include parts that are not disposed at equal intervals. For example, one of the four attraction pieces 23 may be omitted in the present embodiment.

The number of the attraction pieces 24 of the attraction section 22 and the number of the attraction pieces 35 of the attraction section 34 do not necessarily have to be equal to each other. In a case where the finger ring member 30 can be firmly fixed to the stationary member 20 simply with the magnetic force by which the attraction piece 24 and the attraction piece 36 are attracted, for example, the number of the attraction pieces 23 may be reduced to one and the number of the attraction pieces 35 may be four as in the embodiment described above. Even in this case, the area of the region where the attraction section 22 and the attraction section 34 overlap when viewed from the direction of connection in the vertical state or the lateral state increases and the area of the region where the attraction section 22 and the attraction section 34 overlap when viewed from the direction of connection in the state between the vertical state and the lateral state decreases.

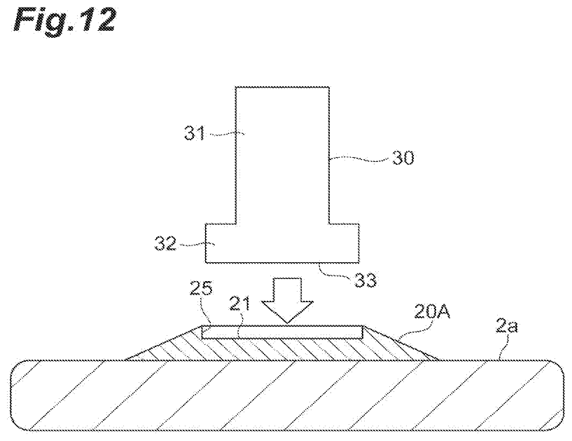

FIG. 12 is a cross-sectional view of a stationary member 20A according to a modification example. Illustrated in FIG. 12 is the cross section of the stationary member 20A that is along a plane which is parallel to the side surface 2b and passes through the center of the connection surface 21. As illustrated in FIG. 12, the stationary member 20A is different from the stationary member 20 in that the stationary member 20A further includes a standing section 25 standing in an annular shape in the peripheral edge portion of the connection surface 21 so as to surround the side surface of the connection section 32 in a state where the connection surface 33 abuts against the connection surface 21. In this case, positional misalignment of the connection surface 33 with respect to the connection surface 21 can be effectively prevented by the standing section 25. The attraction pieces that are provided for connection maintenance, such as the annular attraction pieces 24 and 36, may be omitted in a case where it is unnecessary to supply a magnetic force for connection maintenance and prevent the positional misalignment of the stationary member 20 and the finger ring member 30 by means of a physical (mechanical) structure as described above.

The applications of the connection structure 10 are not limited to holding of the smartphone 1. For example, the stationary member 20 may be fixed to an object other than the smartphone 1. Although the finger ring member 30 has been exemplified as a member connected to the stationary member 20 in the present embodiment, the member connected to the stationary member 20 is not limited to members attached to a user's finger. In a case where it is desired to connect two objects in a relatively rotatable manner, for example, the stationary member 20 may be attached to one of the objects and the member that is connected to the stationary member 20 (member corresponding to the finger ring member 30 of the present embodiment) may be attached to the other object. In this case, the two objects can be connected in a relatively rotatable manner by a connection structure similar to the connection structure 10 described in the present embodiment and modulated rotational operation of the other object with respect to one of the objects can be realized.

Although the present invention has been described in detail, it is apparent to those skilled in the art that the present invention is not limited to the embodiments described in this specification. The present invention can be implemented as modified and changed aspects without departing from the spirit and scope of the present invention defined by the description of the claims. Therefore, the description in this specification is for illustrative purposes and does not have any restrictive meaning with respect to the present invention.

Each aspect/embodiment described in this specification may be used alone or in combination.

The terms described in this specification and/or the terms necessary for understanding of this specification may be replaced with terms having the same or similar meanings.

Any reference to the elements using the designations such as “first” and “second” used in this specification does not comprehensively limit the quantities or orders of the elements. The designations can be used in this specification as a convenient method for distinguishing between two or more elements. Therefore, reference to the first and second elements does not mean that only two elements can be adopted there or that the first element should precede the second element in any manner.

Insofar as “including”, “comprising”, and variations thereof are used in this specification or the claims, the terms are intended to be inclusive similarly to the term “provided”. Further, the terms “or” and “or” used in this specification or the claims are not exclusive ORs.

Throughout the present disclosure, the plural is included unless the context clearly indicates the singular.

### REFERENCE SIGNS LIST

10, 110, 210, 310: connection structure, 20, 120, 220, 320: stationary member (first member), 21: connection surface, 22, 121, 221, 321: attraction section (first attraction section), 23, 222, 322, 322a, 322b: attraction piece (first attraction piece), 24, 123, 223, 323: attraction piece (third attraction piece), 30, 130, 230, 330: finger ring member (second member), 33: connection surface, 34, 131, 231, 331: attraction section (second attraction section), 35, 132, 232, 332, 332a, 332b: attraction piece (second attraction piece), 36, 133, 233, 333: attraction piece (fourth attraction piece), C: rotation axis.

1. A connection structure connecting a first member and a second member with a magnetic force, wherein
the first member has a first attraction section including an attraction piece as a magnet or a magnetic body,
the second member has a second attraction section including an attraction piece as a magnet or a magnetic body and connecting the first member and the second member by being attracted to the first attraction section by a magnetic force,
the first attraction section and the second attraction section are formed such that the first member and the second member are connected so as to be rotatable relative to each other about a rotation axis parallel to a direction of connection in which the first member and the second member are connected, and
the first attraction section and the second attraction section are formed such that a magnetic force by which the first attraction section and the second attraction section are attracted is stronger when a relative positional relationship between the first member and the second member in accordance with the relative rotation is any of a plurality of specific positional relationships than when the relative positional relationship is not the specific positional relationship.

2. The connection structure according to claim 1, wherein the first attraction section and the second attraction section are formed such that an area of a region where the first attraction section and the second attraction section overlap each other when viewed from the direction of connection changes in accordance with the relative rotation.

3. The connection structure according to claim 2, wherein
the first attraction section has a plurality of first attraction pieces disposed along a circumference of a circle about the rotation axis, and
the second attraction section has a plurality of second attraction pieces disposed so as to correspond to the plurality of first attraction pieces.

4. The connection structure according to claim 3, wherein
the plurality of first attraction pieces include the first attraction piece having a first polarity and the first attraction piece having a second polarity opposite to the first polarity, the first attraction pieces having the polarities being disposed in accordance with a predetermined distribution determined in advance, and
the plurality of second attraction pieces include the second attraction piece having the first polarity and the second attraction piece having the second polarity, the second attraction pieces having the polarities being disposed so as to correspond to the plurality of first attraction pieces.

5. The connection structure according to claim 1, wherein
the first attraction section has a third attraction piece, and
the second attraction section has a fourth attraction piece formed such that an area of a region overlapping the third attraction piece when viewed from the direction of connection does not change regardless of the relative positional relationship.

6. (canceled)

7. The connection structure according to claim 2, wherein
the first attraction section has a third attraction piece, and
the second attraction section has a fourth attraction piece formed such that an area of a region overlapping the third attraction piece when viewed from the direction of connection does not change regardless of the relative positional relationship.

8. The connection structure according to claim 3, wherein
the first attraction section has a third attraction piece, and
the second attraction section has a fourth attraction piece formed such that an area of a region overlapping the third attraction piece when viewed from the direction of connection does not change regardless of the relative positional relationship.

9. The connection structure according to claim 4, wherein
the first attraction section has a third attraction piece, and
the second attraction section has a fourth attraction piece formed such that an area of a region overlapping the third attraction piece when viewed from the direction of connection does not change regardless of the relative positional relationship.

10. The connection structure according to claim 5, wherein the third attraction piece and the fourth attraction piece are formed in an annular shape about the rotation axis.

11. The connection structure according to claim 7, wherein the third attraction piece and the fourth attraction piece are formed in an annular shape about the rotation axis.

12. The connection structure according to claim 8, wherein the third attraction piece and the fourth attraction piece are formed in an annular shape about the rotation axis.

13. The connection structure according to claim 9, wherein the third attraction piece and the fourth attraction piece are formed in an annular shape about the rotation axis.
